(19) United States
(12) Patent Application Publication
(10) Pub. No.: US 2017/0008356 A1
(43) Pub. Date: Jan. 12, 2017

(54) SNOW TIRE COVER

(71) Applicant: Soo Young LEE, Suwon-si (KR)

(72) Inventor: Soo Young LEE, Suwon-si (KR)

(21) Appl. No.: 15/110,891

(22) PCT Filed: Jun. 24, 2014
(86) PCT No.: PCT/KR2014/005577

§ 371 Date: Jul. 11, 2016

(30) Foreign Application Priority Data
Jan. 9, 2014 (KR) 20-2014-0000191

(51) Int. Cl. B60C 27/10; B60C 27/20; B60C 27/06

(52) U.S. Cl. CPC B60C 27/10; B60C 27/065; B60C 27/064; B60C 27/20

(57) ABSTRACT

There is provided a tire cover for snow including a plurality of cover bodies covering the tire elastically, and including a tread cover part covering a tread of the tire, an inner cover part extending from both sides of the tread cover part and covering the inner surface of the tire, and an outer cover part covering the outer surface of the tire; and a braking pin including a head part, a neck part extending from the rear surface of the head part and having the smaller cross-section area than the head part, a supported plate part extending from the rear surface of the neck part and having the larger cross-section area than the neck part, and a pin part protruding from the rear surface of the supported plate part, wherein the braking pin is coupled to the cover body in order that the head part protrudes to the outer area of the tread cover part and the pin part protrudes to the inner area of the tread cover part, and the pin part is inserted to the tire when covering the cover bodies to the tire.

### CROSS-REFERENCE TO RELATED APPLICATIONS

This application is a 371 of PCT/KR2013/011598 filed Dec. 13, 2013, which claims the benefit of foreign priority of Korean Patent Application No. 10-2013-0034232 filed Mar. 29, 2013, the subject matter of which is hereby incorporated by reference in its entirety.

### TECHNICAL FIELD

The present invention relates to a tire cover for snow, and in particular, it relates to a tire cover for snow which can provide excellent braking power, reliable safety by being coupled to a tire strongly, and can be easily installed to and separated from a tire.

### BACKGROUND ART

Usually, when driving a motor vehicle on the snowy road, a chain for snow is installed to a tire to prevent the motor vehicle from sliding over snow. Most-used chain for snow is manufactured by weaving a metallic material chain. The chain for snow made of metallic material chain is very hard to be installed to the tire. Additionally, it causes a terrible noise while the chain beats the ground and a comfortable ride is impossible because the motor vehicle shakes terribly due to the wide gap between the chains. Moreover, the metallic material chain causes a severe damage to the road.

In order to solve the aforementioned problem of the metallic chain for snow, a chain for snow made of urethane is also used but it is also hard to be installed to the tire. A chain covering only half of the tire, named a spider chain, or a chain made of fabric is also used. However, the spider chain is also hard to be installed to the tire because it must be installed to the tire using an adaptor which is installed to the bolt holes of the wheel after loosening the bolt of the wheel. The fabric chain is easy to be installed to the tire but it is easy to be torn due to weak durability and cannot produce sufficient braking power.

### DISCLOSURE

### Technical Problem

To solve the above problems, an object of the present invention is to provide a tire cover for snow, capable of installing to and separating from the tire easily, causing no noise, not reducing a comfortable ride, and causing no damage to the road.

### Technical Solution

In accordance with an aspect of the present invention, there is provided a tire cover for snow includes: a plurality of cover bodies covering the tire elastically, and including a tread cover part covering a tread of the tire, an inner cover part extending from both sides of the tread cover part and covering the inner surface of the tire, and an outer cover part covering the outer surface of the tire; and a braking pin including a head part, a neck part extending from the rear surface of the head part and having the smaller cross-section area than the head part, a supported plate part extending from the rear surface of the neck part and having the larger cross-section area than the neck part, and a pin part protruding from the rear surface of the supported plate part, wherein the braking pin is coupled to the cover body in order that the head part protrudes to the outer area of the tread cover part and the pin part protrudes to the inner area of the tread cover part, and the pin part is inserted to the tire when covering the cover bodies to the tire.

In accordance with another aspect of the present invention, the outer peripheral surface of the tread cover part may be formed with a plurality of braking protrusions, and the height of the braking protrusions from the outer surface of the tread cover part may be same with the height of the head part of the braking pin from the outer surface of the tread cover part.

In accordance with another aspect of the present invention, the end portion of the inner surface cover part and the outer surface cover part may be formed with grips protruding to the outer area, the grips may be formed with coupling grooves in which a rubber ring is coupled detachably, and an engaging force may be produced between the cover bodies by the rubber band, when coupling the rubber ring in the coupling groove formed on the outer surface cover part of the cover bodies covering the tire.

In accordance with another aspect of the present invention, both end portions of the cover body may be formed with an elastic band having shape corresponding to the cross-section of the cover body, and the elastic band may cover the tire elastically, when the cover body covers the tire.

In accordance with another aspect of the present invention, the end portion of the inner surface cover part may be formed with a plurality of inner end portion rings, and the tire cover for snow further includes an inner rubber ring coupled in the inner end portion rings, when the cover bodies cover the tire.

In accordance with another aspect of the present invention, the end portion of the outer surface cover part may be formed with a plurality of outer end portion rings, and the tire cover for snow further includes an outer rubber ring coupled in the inner end portion rings, when the cover bodies cover the tire.

In accordance with another aspect of the present invention, the end portion of the inner surface cover part may be formed with a plurality of inner end portion rings, the end portion of the outer surface cover part may be formed with a plurality of outer end portion rings, and the tire cover for snow further includes a plurality of subsidiary rubber rings coupled between the inner end portion rings and the outer end portion rings and extending through a through hole formed on the disk of the wheel to which the tire installed.

In accordance with another aspect of the present invention, the end portion of the inner surface cover part may be formed with a plurality of inner end portion rings, the end portion of the outer surface cover part may be formed with a plurality of outer end portion rings, and the tire cover for snow further includes an inner rubber ring coupled in the inner end portion rings when the cover bodies cover the tire, an outer rubber ring coupled in the inner end portion rings, and a plurality of subsidiary rubber rings coupled between the inner end portion rings and the outer end portion rings and extending through a through hole formed on the disk of the wheel to which the tire installed.

### Advantageous Effects

In accordance with the aforementioned structure of the present invention, the cover body is installed to or separated from the tire in one-touch type manner. Accordingly, women or the aged can easily use without any difficulty.

Especially, braking power is produced while the head part of the braking pin gets stuck in snow and additional braking power is produced by the braking protrusion formed on the tread cover part. Accordingly, reliable braking power without sliding over snow can be obtained.

Moreover, because the tire and the cover body are bonded each other by inserting the pin part of the braking pin to the tire, the spinning or sliding of the tire can be prevented.

Further, unlike the conventional chain for snow, because no noise and vibration generates during driving comfortable ride is possible and there is no concern about damage to a road.

Meanwhile, in accordance with the present invention, the inner rubber ring can be putted in the inner end portion ring without any interruption caused by an axle using the inner, outer supporting protrusions of the cover body. Accordingly, because an engaging force to the cover bodies is produced by putting the inner rubber ring, the cover bodies can be coupled each other strongly and an engaging force to the tire can be also enhanced. Accordingly, because the cover body is fixed to the tire strongly there is no concern about the cover body is separated while driving and the safety is reliable.

Especially, in accordance with the present invention, because an engaging force between the inner surface cover parts of the cover bodies is produced by putting the inner cover ring in the inner cover part of the cover body, coupling between the cover body and the tire is possible even in case that the cover body is not coupled to the tire elastically. Accordingly, women or the aged can easily install and use single-handed without any difficulty. Moreover, coupling between the tire and cover body can be obtained using the outer rubber ring and the subsidiary rubber ring.

### DESCRIPTION OF DRAWINGS

FIG. 1 is an exploded perspective view of a tire cover for snow in accordance with an exemplary of the present invention.

FIG. 2 is a partially enlarged view of ‘A’ in FIG. 1.

FIG. 3 is a perspective view of the braking pin in accordance with the exemplary of the invention.

FIG. 4 is a perspective view of a tire to which the exemplary embodiment of the present invention is applied.

FIG. 5 is a side view of a tire to which the exemplary embodiment of the present invention is applied.

FIG. 6 is an exploded perspective view of a tire cover for snow in accordance with another exemplary embodiment of the present invention.

FIG. 7 is an exploded perspective view of FIG. 6 in different direction.

FIG. 8 is a partially enlarged view of ‘A’ in FIG. 6.

FIG. 9 to FIG. 13 is a side view of a tire to which the exemplary embodiment of the present invention is applied.

FIG. 14 is an inner perspective view of a tire to which the exemplary embodiment of the present invention is applied.

FIG. 15 is an outer perspective view of a tire to which the exemplary embodiment of the present invention is applied.

### BEST MODE

### Mode for Invention

An exemplary embodiment of the present invention will be described in detail with reference to the accompanying drawings.

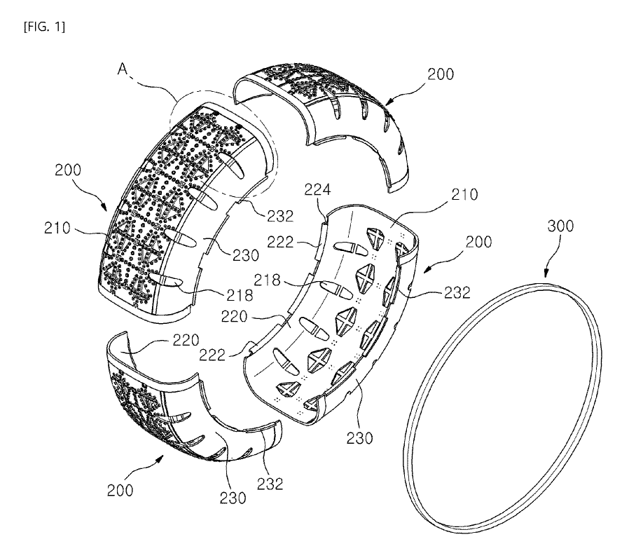

FIG. 1 to FIG. 3 shows an exemplary embodiment of the present invention. FIG. 4 and FIG. 5 are a perspective view and a side view of a tire to which the exemplary embodiment of the present invention is applied. As shown in drawings, a tire cover for snow in accordance with an exemplary embodiment of the present invention includes a plurality of braking pins 50, a plurality of cover bodies 20 covering a tire 2, a rubber ring 30, and a metallic elastic band 40.

The braking pin 50 includes a head part 51 in square plate shape, a neck part 53 protruding from the rear surface of the head part 51 and having the smaller cross-section area than the head part 51, a supported plate part 54 in square plate shape protruding from the rear surface of the neck part 53 and having the larger cross-section area than the neck part 53, and a plurality of pin parts 55 protruding from the rear surface of the supported plate part 54. The pin part 55 has a length of about 3mm, and its end portion is formed to be sharp.

The braking pin 50 is made of metallic material, more preferably corrosion-resisting material such as brass or titanium in order to prevent from corrosion caused by deicing agent including calcium chloride. As shown in drawings, preferably, a cross-shaped concave groove 52 is formed on the upper surface of the head part 51.

The cover body 20 includes a tread cover part 10 formed in curved shape in order to cover the outer peripheral surface, namely the tire tread of the tire 2, and inner, outer surface cover parts 25, 23 extended from both sides of the tread cover part 10 in order to cover the inner surface and outer surface of the tire 2. The cover body 20 has U-shaped cross sectional surface. The cover body 20 has the length to cover one-fourth (¼) tire and circular arc shape so that four (4) cover bodies 20 can be one set. Accordingly, the tire 2 is entirely covered by fitting four (4) cover bodies 20 to the tire 2.

The cover body 20 is molded using urethane resin. In case that the hardness of the cover body 20 is too low, the cover body 20 can be fragile, and in case that too high, braking power of the cover body 20 can be weakened. Accordingly, the hardness of the cover body 20 is properly adjusted considering the aforementioned factors.

The end portion of the inner, outer surface cover parts 25, 23 is formed to be bent inward slightly in order to produce an elastic force. Accordingly, when fitting the cover body 20 to the tire 2, the end portion of the inner, outer surface cover parts 25, 23 is getting wider and the cover body 20 is fitted to the tire 2. After fitting to the tire 2, the inner, outer surface cover parts 25, 23 is restored elastically and the cover body 20 is fixed to the tire 2 elastically.

Meanwhile, the cover body 20 can be injection-molded. During the injection-molding of the cover body 20, the braking pin 50 is inserted to the tread cover part 10 of the cover body 20 in order to couple the braking pin 50 to the cover body 20. The braking pin 50 is inserted to the tread cover part 10 in predetermined arrangement.

As shown in drawings, the neck part 53 and the supported plate part 54 penetrate the tread cover part 10 while the bottom surface of the supported plate part 54 of the braking pin 50 has the same surface with the inner surface of the tread cover part 10. Accordingly, the head part 51 of the braking pin 50 protrudes to the outer area of the tread cover part 10, and the pin part 51 protrudes to the inner area of the tread cover part 10. The braking pin 50 is not easily separated from the tread cover part 10 because the tread cover part 10 is trapped in the head part 51 of the braking pin 50 and supported plate part 54.

Additionally, a plurality of braking protrusions 16 in circular ring shape are formed on the outer peripheral surface of the tread cover part 10. The braking protrusions 16 can have the same height with or the slightly lower height than the top surface of the head part 51 of the braking pin 50 which inserted to the tread cover part 10, for example, the braking protrusions 16 can have about 2mm lower height than the top surface of the head part 51 of the braking pin 50. In case that the braking protrusions 16 have the same height with the braking pin 50, a noise generated when the braking pin 50 contacts the ground can be reduced. In this configuration, braking power does not still become weakened because there is a space around the head part of the braking pin and the braking protrusions have the flexibility comparing with the metallic pin.

Reference numeral 18 indicates a decorative hole formed on the tread cover part 10 and the inner, outer surface cover parts 25, 23. By forming the decorative hole 18, the cover body 20 is not only decorated but also lightened by reducing molding materials for cover body 20. Especially, by forming the decorative hole 18, damage to the cover body 20 can be prevented because the cover body 20 can modify its form more flexibly in response to the impact on the cover body 20 during driving.

Additionally, a metallic elastic band 40 is inserted to both end portions of the cover body 20 in longitudinal direction. The metallic elastic band 40 has the shape corresponding to the cross sectional surface of the cover body 20 and inserted during the injection-molding of the cover body 20. By molding the cover body 20 with inserting the metallic elastic band 40 thereto, the metallic elastic band 40 produces more strong elastic force to the inner surface cover part 25 and the outer surface cover part 23. Consequently, when the cover body 20 covers the tire 2, the elastic band 40 helps the cover body 20 cover the tire 2 more strongly and elastically.

Additionally, grips 22, 32 protruding to the outer area are formed on the end portion of the inner, outer surface cover parts 25, 23. Accordingly, when separating the cover body 20 from the tire 2, the cover body 20 can be easily separated by pulling the grips 22, 32 by hand.

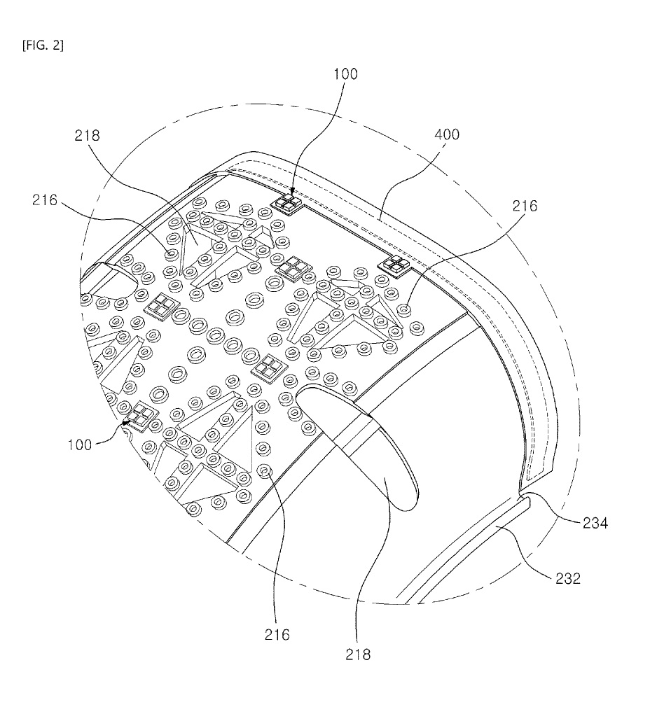

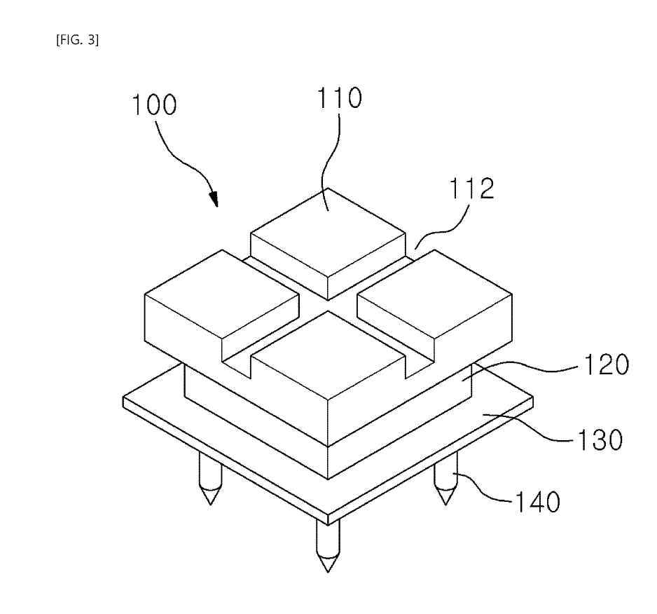

Meanwhile, coupling grooves 24, 34 for putting a rubber ring 300 are formed on the grips 22, 32. As shown in FIG. 3 and FIG. 4, when installing four (4) cover bodies 20 to the tire 2, the coupling grooves 24, 34 are connected in ring shape. The rubber ring 30 is put in the coupling groves 24, 34 connected in ring shape in this manner.

As described below, in case of shown in FIG. 1, the rubber ring 30 is only put in the outer surface cover part 23. However, if the coupling grooves 24, 34 are formed on both inner, outer surface cover parts 25, 23, the cover body 20 can be used regardless of the directionality because the inner, outer surface cover parts 25, 23 of the cover body 20 have the same shape.

The rubber ring 30 can be a rubber band with a predetermined thickness and in ring shape. When putting the rubber ring 30 in the coupling groove 34, an engaging force can be produced between the neighboring cover bodies 20, and an engaging force with the tire 2 can also be enhanced by bending the cover body 20 inward slightly.

Hereinafter, the assembling process of the tire cover for snow in accordance with the present invention will be described in detail.

After the tire 2 comes out of the car body by turning the steering wheel to the end, the cover body 20 having the braking pin 50 is installed to cover the tire 2. That is, by pressing the cover body 20 to the tire 2, the inner, outer surface cover parts 25, 23 are getting wider and the cover body 20 is fitted to the tire 2. After this, the inner, outer surface cover parts 25, 23 are restored elastically and the cover body 20 is fixed to the tire 2 elastically. Thus, it can be easily installed because of the one-touch type installing of the cover body 20.

When installing the cover body 20 to cover the tire 2 and pressing the cover body 20 in order for the pin part 55 of the braking pin 50 to be inserted to the tire, slight pressing is sufficient to insert the pin part 55 to the tire 2 because the end portion of the pin part 55 is formed to be sharp. Generally, a tread pattern of the tire 2 has a thickness of about 8 mm and the tire 2 is replaced before the thickness of the tread pattern becomes about 2.8 mm. Although the tire 2 is a heavily worn tire the tread pattern has a thickness of above 2.8 mm at least and the tire tread has its own predetermined thickness. Accordingly, as described above, when inserting the pin part 55 having a thickness of about 3mm to the tire 2, there is no concern about the tire 2 becomes flat.

Thus, by inserting the pin part 55 of the braking pin 50 to the tire 2, an engaging force between the cover body 20 and the tire can be enhanced through the braking pin 50.

After fitting four (4) cover bodies 20 to the tire 2, the rubber ring 30 is put in the coupling groove 34 formed on the outer surface cover part 23 of the cover body 20. By putting the rubber ring 30, an engaging force can be produced between the cover bodies 20 and an engaging force between the cover body 20 and the tire 2 can be enhanced. Accordingly, because the cover body 20 is fixed to the tire 2 more strongly there is no concern about the cover body 20 is separated while driving.

Meanwhile, in case of separating the cover body 20 from the tire 2, after removing the rubber ring 30, the cover body is pulled using the grips 22, 32. In this manner, the cover body 20 can be separated while the inner, outer surface cover parts 25, 23 are getting wider elastically.

As the exemplary embodiment of the tire cover for snow in accordance with the present invention, the cover body 20 is installed to or separated from the tire 2 in one-touch type manner by pressing or pulling the cover body 20 to the tire 2. Accordingly, women or the aged can easily install and use single-handed.

The tire cover for snow in accordance with the present invention produces braking power during driving through the head part 51 of the braking pin 50 and the braking protrusion 16. Primarily, braking power is produced while the head part 51 protruding relatively more than the braking protrusion 16 gets stuck in snow and additional braking power is produced by the braking protrusion 16. Accordingly, by braking power as described above, reliable braking effect without sliding over snow can be obtained.

FIG. 6 to FIG. 15 shows another exemplary embodiment of the present invention.

In reference to the figures, a tire cover for snow in accordance with the present invention includes a plurality of cover bodies 100 covering a tire 2 (shown in FIG. 9), a plurality of braking pins 200 coupled to the cover body 100, and an inner rubber ring 310 and outer rubber ring 320.

The cover body 100 includes a tread cover part 110 formed in curved shape in order to cover the outer peripheral surface, namely the tire tread of the tire 2, and inner, outer surface cover parts 120, 130 extended from both sides of the tread cover part 110 in order to cover the inner surface and outer surface of the tire 2. The cover body 100 has U-shaped cross sectional surface.

The cover body 100 has the length to cover one-fourth (¼) tire and circular arc shape so that four (4) cover bodies 100 can be one set. Accordingly, the tire 2 is entirely covered by fitting four (4) cover bodies 100 to the tire 2. The cover body 100 is molded using resin or rubber, preferably abrasion-resisting material like urethane resin or urethane rubber.

A plurality of inner end portion rings 122 are formed on the end portion of the inner surface cover part 120, and a plurality of inner supporting protrusions 124 are formed on the outer surface of the inner surface cover part 120 apart from each other with predetermined distance. A supporting hook 125 having the expanded diameter is formed on the end portion of the inner supporting protrusion 124.

The inner supporting protrusion 124 is located near to the base end portion of the inner surface cover part 120. As described below, this is for, when putting an inner rubber ring 310 in the inner supporting protrusion 124, easy putting of the inner rubber ring 310 by exposing the inner supporting protrusion 124 outward even more.

Additionally, a plurality of outer end portion rings 132 are formed on the end portion of the outer surface cover part 130, and a plurality of outer supporting protrusions 134 are formed on the outer surface of the outer surface cover part 130 apart from each other with predetermined distance. A supporting hook 135 having the expanded diameter is also formed on the end portion of the outer supporting protrusion 134.

A decorative hole 118 is formed on the tread cover part 110 and the inner, outer surface cover parts 120, 130. By forming the decorative hole 118, the cover body 100 is not only decorated but also lightened. Especially, by forming the decorative hole 118, damage to the cover body 100 can be prevented because the cover body 100 can modify its form more flexibly in response to the impact on the cover body 100 during driving.

Meanwhile, the braking pin 200 is substantially same with the braking pin 50 as shown in FIG. 3. That is, as shown in FIG. 3, it includes a head part 51, a neck part 53, a supported plated part 54, and a plurality of pin parts 55. The pin part 55 has a length of about 3mm, and its end portion is formed to be sharp.

The braking pin 200 is made of metallic material, more preferably corrosion-resisting material such as brass or titanium, in order to prevent from corrosion caused by deicing agent including calcium chloride.

The braking pin 200 is coupled in many so as to penetrate the tread cover part 110. The braking pin 200 is coupled so that the neck part 53 and the supported plate part 54 penetrate the tread cover part 110 while the bottom surface of the supported plate part 54 has the same surface with the inner surface of the tread cover part 110.

Accordingly, the head part 51 of the braking pin 200 protrudes to the outer area of the tread cover part 110, and the pin part 55 protrudes to the inner area of the tread cover part 110. The braking pin 200 is not easily separated from the tread cover part 110 by the head part 51 of the braking pin 200 and supported plate part 54. Preferably, during the molding of the cover body 100, the braking pin 200 is inserted to the cover body 100.

Additionally, a plurality of braking protrusions 116 in circular ring shape are formed on the outer peripheral surface of the tread cover part 110. The braking protrusions 116 can have the same height with or the slightly lower height than the top surface of the head part 51 of the braking pin 100 which coupled to the tread cover part 110.

Meanwhile, an inner rubber ring 310 and an outer rubber ring 320 are made of urethane rubber etc. which has flexibility and durability, and putted in the inner end portion ring 122 and the outer end portion ring 132 respectively as described below. In accordance with the exemplary embodiment, a plurality of subsidiary rubber rings 330 is included.

Hereinafter, the installing process of the tire cover for snow in accordance with the present invention to the tire 2 of the wheel 6 will be described in detail.

After the tire 2 comes out of the car body by turning right the steering wheel to the end, the cover body 100 having the braking pin 200 is fitted to the rear portion the tire 2. Subsequently, the cover body 100 is pressed in order for the pin part 55 of the braking pin 200 to be inserted to the tire 2. Slight pressing is sufficient to insert the pin part 55 to the tire 2 because the end portion of the pin part 55 is formed to be sharp.

Thus, by inserting the pin part 55 of the braking pin 200 to the tire 2, the cover body 100 is primarily fixed to the tire 2 through the braking pin 200.

After fitting four (4) cover bodies 100 to the tire 2 in this manner, as shown in FIG. 9, the subsidiary rubber rings 330 are putted between the inner end portion ring 122 of the inner surface cover part 120 and the outer end portion ring 132 of the outer surface cover part 130 through a through hole 7 formed on the disk part of the wheel 6.

When putting the subsidiary rubber ring 330 between the inner end portion ring 122 and the outer end portion ring 132, the cover body 100 is fixed to the tire 2 by pulling the inner cover part 120 and the outer cover part 130 inward. Especially, in case that some of the subsidiary rubber ring 330 is putted in the neighboring cover body 100 simultaneously, the engaging force between the cover bodies 100 is also enhanced.

Then, the outer rubber ring 320 is putted in the outer end portion ring 132 of the cover body 100.

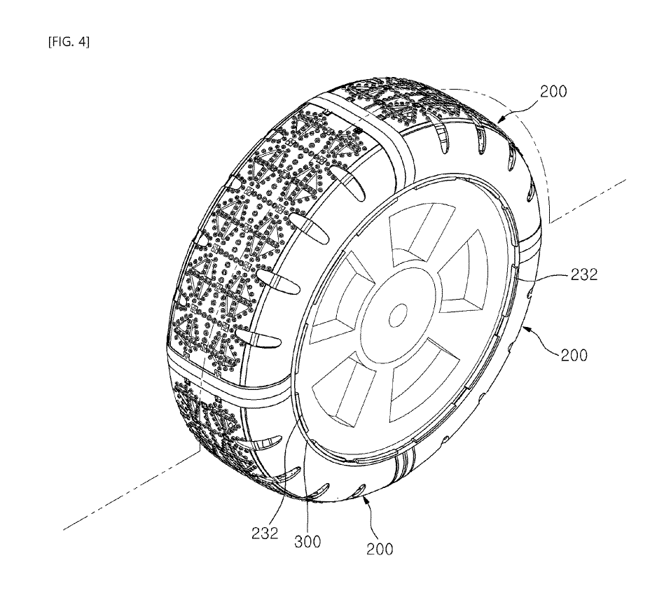

Subsequently, as shown in FIG. 10, the inner rubber ring 310 is putted in the outer supporting protrusions 134 formed on two (2) cover bodies 100 located in the upper portion among four (4) cover bodies 100 installed. When putting the inner rubber ring 310 in the outer supporting protrusions 134, the inner rubber ring 310 is putted in semicircular shape.

Then, after the rear portion of the tire 2 comes out by turning right the steering wheel to the end, by pulling the inner rubber ring 310 of the rear portion of the tire 2 putted in the outer supporting protrusions 134 and passing it to the inner portion of the cover body 100, as shown in FIG. 11 and FIG. 12, the inner rubber ring 310 is putted in the inner supporting protrusions 124 of the inner cover part 120.

Subsequently, after the front portion of the tire 2 comes out by turning left the steering wheel to the end, by pulling the inner rubber ring 310 of the front portion of the tire 2 putted in the outer supporting protrusions 134 and passing it to the inner portion of the cover body 100, the inner rubber ring 310 is putted in the inner supporting protrusions 124 of the inner cover part 120.

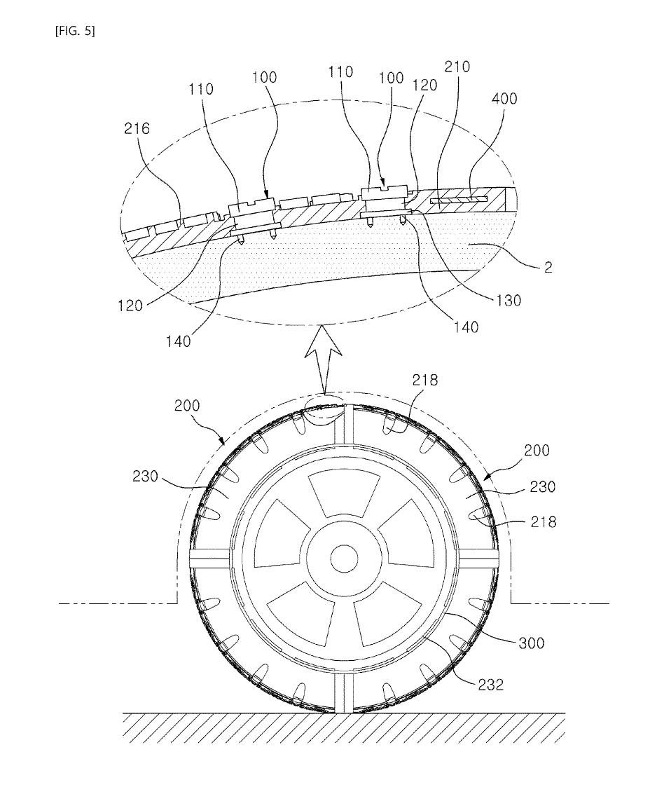

After this, as shown in FIG. 13, by passing half of the inner rubber ring 310 to the inner portion of the cover body 100 entirely, the inner rubber ring is putted in the inner supporting protrusions 124. At this time, the inner rubber ring 310 is putted in some of the inner end portion rings 122.

Then, by tuning the steering wheel in order for the tire 2 to face straight, and moving the motor vehicle as much as half (½) of the diameter of the tire, the cover body 100, that the inner rubber ring 310 is putted in the inner supporting protrusions 124 and the inner end portion rings 122 of the cover body, is located to downward. At this time, because half portion of the inner ring 310 is still located at the outer cover part 130, through the same process as descried above, by passing the inner rubber ring 310 to the inner surface cover part 120, the inner rubber ring 310 in putted in the inner end portion ring 122 of the inner cover part 120.

Though this process, as shown in FIG. 14, the inner rubber ring 310 is putted in the inner end portion ring 122 with sharing a concentric circle with the axle. Accordingly, by putting the inner rubber ring 310, an engaging force can be produced to the inner cover part 120 of the cover body 100 and an engaging force of the cover body 100 to the tire 2 can be also enhanced.

In accordance with the present invention, because an engaging force to the outer cover part 130 of the cover body 100 is produced by putting the outer rubber ring 320, and an engaging force to the inner cover part 120 of the cover body 100 is produced by putting the inner rubber ring 310, the cover bodies 100 can be coupled each other strongly and an engaging force to the tire 2 can be also enhanced. Accordingly, because the cover body 100 is fixed to the tire 2 strongly there is no concern about the cover body 200 is separated while driving and the safety is reliable.

In accordance with the present invention, an engaging force to the tire can be enhanced comparing with the conventional tire cover for snow, and it is easy to be installed to the tire 2.

Meanwhile, in accordance with the present invention, the head part 51 of the braking pin 200 and the braking protrusion 116 produce braking power during driving. Primarily, braking power is produced while the head part 51 gets stuck in snow and additional braking power is produced by the braking protrusion 116. Accordingly, by braking power as described above, reliable braking effect without sliding over snow can be obtained.

Especially, because the pin part 55 of the braking pin 200 is putted to the tire 2, the spinning or sliding of the tire 2 over the tire cover for snow can be prevented. Moreover, in accordance with the present invention, because no noise and vibration generates comparing with the conventional chain for snow comfortable ride is possible and there is no concern about damage to a road.

1-4. (canceled)

5. A tire cover for snow comprising:
a plurality of cover bodies covering the tire elastically, and including a tread cover part covering a tread of the tire, an inner cover part extending from both sides of the tread cover part and covering the inner surface of the tire, and an outer cover part covering the outer surface of the tire; and
a braking pin including a head part, a neck part extending from the rear surface of the head part and having the smaller cross-section area than the head part, a supported plate part extending from the rear surface of the neck part and having the larger cross-section area than the neck part, and a pin part protruding from the rear surface of the supported plate part, wherein the braking pin is coupled to the cover body in order that the head part protrudes to the outer area of the tread cover part and the pin part protrudes to the inner area of the tread cover part, and the pin part is inserted to the tire when covering the cover bodies to the tire.

6. The tire cover for snow of claim 5, wherein the outer peripheral surface of the tread cover part is formed with a plurality of braking protrusions, and
the height of the braking protrusions from the outer surface of the tread cover part is same with the height of the head part of the braking pin from the outer surface of the tread cover part.

7. The tire cover for snow of claim 5, wherein the end portion of the inner surface cover part and the outer surface cover part is formed with grips protruding to the outer area,
the grips are formed with coupling grooves in which a rubber ring is coupled detachably, and
an engaging force is produced between the cover bodies by the rubber band, when coupling the rubber ring in the coupling groove formed on the outer surface cover part of the cover bodies covering the tire.

8. The tire cover for snow of claim 5, wherein both end portions of the cover body is formed with an elastic band having shape corresponding to the cross-section of the cover body, and
the elastic band covers the tire elastically, when the cover body covers the tire.

9. The tire cover for snow of claim 5, wherein the end portion of the inner surface cover part is formed with a plurality of inner end portion rings, and
further comprising an inner rubber ring coupled in the inner end portion rings, when the cover bodies cover the tire.

10. The tire cover for snow of claim 5, wherein the end portion of the outer surface cover part is formed with a plurality of outer end portion rings, and
further comprising an outer rubber ring coupled in the inner end portion rings, when the cover bodies cover the tire.

11. The tire cover for snow of claim 5, wherein the end portion of the inner surface cover part is formed with a plurality of inner end portion rings,
the end portion of the outer surface cover part is formed with a plurality of outer end portion rings, and
further comprising a plurality of subsidiary rubber rings coupled between the inner end portion rings and the outer end portion rings and extending through a through hole formed on the disk of the wheel to which the tire installed.

12. The tire cover for snow of claim 5, wherein the end portion of the inner surface cover part is formed with a plurality of inner end portion rings,
the end portion of the outer surface cover part is formed with a plurality of outer end portion rings, and
further comprising an inner rubber ring coupled in the inner end portion rings when the cover bodies cover the tire, an outer rubber ring coupled in the inner end portion rings, and a plurality of subsidiary rubber rings coupled between the inner end portion rings and the outer end portion rings and extending through a through hole formed on the disk of the wheel to which the tire installed.
